(19) United States
(12) Patent Application Publication
(10) Pub. No.: US 2026/0194481 A1
(43) Pub. Date: Jul. 9, 2026

(54) INFORMATION PROCESSING SYSTEM, INFORMATION PROCESSING METHOD, AND PROGRAM

(71) Applicant: TOPOLOGIC INC., Tokyo (JP)

(72) Inventor: Arata TAKAHASHI, Tokyo (JP)

(21) Appl. No.: 19/131,800

(22) PCT Filed: Dec. 21, 2023
(86) PCT No.: PCT/JP2023/045901

§ 371 Date: May 21, 2025

(30) Foreign Application Priority Data
Dec. 29, 2022 (JP) 2022-212812

(51) Int. Cl. G01N 25/32; G01N 25/34

(52) U.S. Cl. CPC G01N 25/32; G01N 25/34

(57) ABSTRACT

An information processing system for a sensor unit is provided in which the sensor unit comprises at least one concentration sensor configured to come into contact with fluid and output an electromotive force having a correlation with a concentration of target particles contained in the fluid, the concentration sensor comprises a first thermoelectric conversion part; an interaction portion; and a first temperature adjustment part, and the information processing system comprises at least one control circuit configured to execute: an acquisition step of acquiring, from the sensor unit, at least a measurement result and a value related to the temperature of the interaction portion; and an output step of outputting a concentration of the target particles contained in the fluid corrected by using a correction value, based on the correction value specified based on a value related to the temperature of the interaction portion and the measurement result.

### CROSS REFERENCE TO RELATED APPLICATIONS

This application is a 371 U.S. National Phase of International Application No. PCT/JP2023/045901, filed on Dec. 21, 2023, which claims priority to Japanese Patent Application No. 2022-212812, filed Dec. 29, 2022. The entire disclosures of the above applications are incorporated herein by reference.

### BACKGROUND

### Technical Field

The present disclosure relates to an information processing system, an information processing method, and a program.

### Related Art

WO 2022/176966 A1 discloses a technology for providing a thermoelectric device that can be miniaturized with a simple configuration.

The thermoelectric device includes a sheet or plate-shaped thermoelectric conversion film having a thermoelectric conversion element made of a material exhibiting the anomalous Nernst effect, and a high thermal conductivity insulation film provided on at least the first surface of the thermoelectric conversion film and made of an insulator having a thermal conductivity higher than that of a material of the thermoelectric conversion element. The thermoelectric device can be applied to gas sensors and further includes a catalyst part made of a catalyst that reacts to the heat of the gas. The catalyst part is provided in at least a partial area of the surface of the high thermal conductivity insulation film so as to face a flow path of the gas.

However, there is still room for improvement in technology for increasing the versatility of sensor units such as gas sensors that utilize thermoelectric devices.

### SUMMARY

According to an aspect of the present disclosure, an information processing system for a sensor unit is provided. The sensor unit in the information processing system includes at least one concentration sensor. At least one concentration sensor is configured to come into contact with fluid and output an electromotive force that has a correlation with a concentration of target particles contained in the fluid, and includes a first thermoelectric conversion part, an interaction portion, and a first temperature adjustment part. The first thermoelectric conversion part is configured to generate the electromotive force due to a temperature gradient and includes a first measuring surface. The interaction portion is configured to perform heat exchange with the first thermoelectric conversion part via the first measuring surface. The interaction portion is configured so that, when being activated, an amount of heat during the heat exchange changes due to a degree of interaction caused by contact with the target particles contained in the fluid. The first temperature adjustment part is configured to adjust temperature such that the temperature of the interaction portion becomes a preset drive temperature that is higher than a minimum temperature at which the interaction portion can be activated. The information processing system comprises at least one control circuit configured to execute each of following steps. In an acquisition step, at least a measurement result related to the concentration of the target particles and a value related to the temperature of the interaction portion are acquired from the sensor unit. In an output step, a concentration of the target particles contained in the fluid which is corrected by using a correction value is output, based on the correction value specified based on a value related to the temperature of the interaction portion and the measurement result in at least a portion of period from an initial temperature until the temperature of the interaction portion reaches the drive temperature.

According to such a configuration, for example, the versatility of the sensor unit can be improved.

### BRIEF DESCRIPTION OF THE DRAWINGS

FIG. 1 shows an example of a configuration of an information processing system 1.

FIG. 2 is a block diagram showing a hardware configuration of an information processing apparatus 6.

FIG. 3 is an activity diagram showing an example of a flow of information processing executed in an information processing system 1.

FIG. 4 is an activity diagram showing another example of a flow of information processing executed in an information processing system 1.

FIG. 5 shows an example of the configuration of an information processing system 1b.

FIG. 6 is an activity diagram showing an example of a flow of information processing executed in an information processing system 1b.

FIG. 7 shows an example of a concentration sensor 3 in the case where a light source is used as a temperature adjustment part.

### DETAILED DESCRIPTION

Hereinafter, a suitable embodiment of the present disclosure will be described in detail with reference to the accompanying drawings. In this specification and the drawings, components having substantially identical functional configurations are indicated with the same reference signs and duplicate explanations are omitted.

A program for realizing a software in the present embodiment may be provided as a non-transitory computer readable storage medium that can be read by a computer, may be provided for download from an external server, or may be provided in such a manner that the program can be activated on an external computer to realize function thereof on a client terminal (so-called cloud computing).

A term “unit” in the present embodiment may include, for example, a combination of a hardware resource implemented as circuits in a broad sense and information processing of software that can be concretely realized by the hardware resource. Furthermore, various kinds of information are described in the present embodiment, and such information may be represented by, for example, physical values of signal values representing voltage and current, high and low signal values as a set of binary bits consisting of 0 or 1, or quantum superposition (so-called qubits), and communication and computation may be executed on a circuit in a broad sense.

The circuit in a broad sense is a circuit realized by properly combining at least a circuit, circuitry, a processor, a memory, and the like. In other words, a circuit includes an application specific integrated circuit (ASIC), a programmable logic device (e.g., simple programmable logic device (SPLD), a complex programmable logic device (CLPD), field programmable gate array (FPGA), and the like.

From the viewpoint of responsiveness, a heat flow sensor (an example of a device) described below is preferably a thin-film type heat flow sensor based on the anomalous Nernst effect. The element (thermoelectric conversion element) of the heat flow sensor (i.e. thermoelectric conversion device) may be constituted of compounds that exhibit the anomalous Nernst effect. The element may be made of, for example, a topological ferromagnetic material or a topological antiferromagnetic material, which are called Weyl semimetals, or it may be composed of ferrimagnetic materials, or it may be a combination of these. The topological ferromagnetic material may be a metal with a Co₂TX composition, such as Co₂MnGa (where X is any one of Si, Ge, Sn, Al, and Ga), or an alloy of a known topological ferromagnetic material, such as a metal with a composition formula represented by Fe₃X (where X is a stoichiometric or off-stoichiometric composition that is a typical element or transition element such as Al or Ga). The topological antiferromagnetic material may be a known topological antiferromagnetic material such as Mn₃X (where X is one or more elements selected from Sn, Ge, Ga, Pt, Ir, Rh, or a compound thereof). The composition ratio of the alloy constituting the topological ferromagnetic material or topological antiferromagnetic material is not necessarily limited to the above-mentioned stoichiometric composition ratio, and is not particularly limited as long as it has a partially stoichiometric structure. The compound constituting the element may be, for example, an alloy containing a transition metal, and the alloy may be a compound having a crystal structure with kagome lattice planes formed by the transition metal, and may exhibit the anomalous Nernst effect. The ferrimagnetic materials are also not particularly limited, as long as they exhibit the anomalous Nernst effect. The structure of the element is not particularly limited, and any known structures can be used. The elements according to the present embodiment may be provided by sputtering, vapor deposition, MBE, plating, sintering, printing, pasting, etc.

### 1. Outline

For example, in a conventional combustion gas sensor, a platinum wire is heated and the resistance value that varies due to an exothermic or endothermic reaction of H₂ or the like is monitored to measure the gas concentration. However, such a gas sensor has a large heat capacity and thus has a low response speed. In addition, such a gas sensor has a large structure and is difficult to be miniaturized.

Therefore, in the device according to the present embodiment, the system using the device, and the method using this device or this system, for example, a heat flow sensor with high thermal conductivity that exhibits the anomalous Nernst effect is provided on a substrate, a predetermined catalyst layer or an adsorption layer is provided on the top of the heat flow sensor, and a temperature control means is provided to control the temperature by heating, cooling, etc. those layers. This makes it possible to realize a gas sensor having a small heat capacity and a small size, and attaining a high-speed response. If a high-speed response is achieved, it will be possible to measure the dynamics of the concentration of even very light gases such as hydrogen.

### 2. Example of Information Processing System

### 2.1. Example of Configuration of Information Processing System

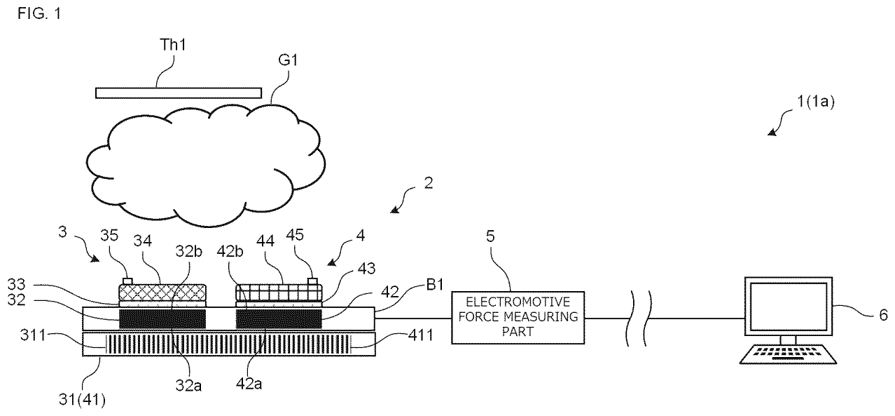

This section describes an example of a configuration of an information processing system according to a first embodiment. FIG. 1 shows an example of the configuration of an information processing system 1. The information processing system 1 is for a sensor unit 2. The sensor unit 2 is configured to output information related to the concentration of the target particles in the fluid. The sensor unit 2 may be configured, for example, to output the detection result of the concentration and inform the user of it, or may be configured to control other devices based on the detection result of the concentration. The fluid may include any phase of substance that allows the flow of the target particles, such as liquids, gases, gels, sols, supercritical fluids, etc. Furthermore, the target particles may be fine particles, such as atoms, molecules, or ions, or they may be an aggregate formed by the fine particles, such as a complex or polymer. As shown in FIG. 1, the information processing system 1 includes a sensor unit 2 and an information processing apparatus 6.

The sensor unit 2 includes at least one concentration sensor 3 (one concentration sensor in the present embodiment).

### <Concentration Sensor 3>

The concentration sensor 3 is configured to come into contact with gas G1, which is an example of fluid, and to output an electromotive force that has a correlation with the concentration of target particles contained in the gas G1. The concentration sensor 3 includes a substrate 31, a heat flow sensor 32, an insulation film 33, a catalyst layer 34, and a thermometer 35. It should be noted that these components are merely examples, and the concentration sensor 3 may include the heat flow sensor 32 and the catalyst layer 34.

### <Substrate 31>

The substrate 31 is a substrate for installing the concentration sensor 3. The substrate 31 may be made of, for example, a material having an electric insulation property. Moreover, the substrate 31 is made of a material having thermal conductivity. In the present embodiment, the substrate 31 is an example of a first temperature adjustment part. The substrate 31 includes a first heater 311. The first heater 311 is configured to generate heat based on a drive signal from the outside.

### <First Heater 311>

The first heater 311 is configured to generate heat based on a drive signal from the outside. In the present embodiment, the first heater 311 is a coil heater that is incorporated into the substrate 31. The coil heater can be implemented, for example, as a laminated chip inductor within the substrate 31 or on the surface of the substrate 31.

### <Heat Flow Sensor 32>

The heat flow sensor 32 is configured to measure information related to the heat flow (e.g., the amount of heat transfer) through the heat flow sensor 32. The heat flow sensor 32 includes a housing B1 and at least one thermoelectric conversion part 321. The housing B1 is configured to house an element such as the thermoelectric conversion part 321 therein. The heat flow sensor 32 of the present embodiment is formed in a film shape and is configured to generate an electromotive force due to the transfer of heat in the thickness direction of the film.

The thermoelectric conversion part 321 is configured to generate an electromotive force due to a temperature gradient. For example, the thermoelectric conversion part 321 can be configured to output an electromotive force based on the anomalous Nernst effect. According to such a configuration, it is possible to provide, for example, the thermoelectric conversion part 321 having a shorter length in the thickness direction than a Seebeck element. The thermoelectric conversion part 321 may be configured to output an electromotive force based on the Seebeck effect. For example, the thermoelectric conversion part 321 includes a connecting surface 32a and a measuring surface 32b as a first measuring surface. The connecting surface 32a is connected to the substrate 31 via the housing B1 and is thus configured to exchange heat with the substrate 31. The measuring surface 32b is a surface that is positioned opposite the connecting surface 32a in the thickness direction of the heat flow sensor 32 in the thermoelectric conversion part 321. The thermoelectric conversion part 321 is configured to output the above-mentioned electromotive force due to the temperature gradient between the connecting surface 32a and the measuring surface 32b.

### <Insulation Film 33>

The insulation film 33 is configured to have an electric insulation property and is provided so as to electrically insulate the measuring surface 32b from an object with which heat is exchanged. In the present embodiment, the insulation film 33 is provided in an area of the housing B1 that faces the measuring surface 32b in the thickness direction of the heat flow sensor 32. The insulation film 33 may be directly laminated on the measuring surface 32b.

### <Catalyst Layer 34>

The catalyst layer 34 is an example of an interaction portion and is configured so that, when being activated, the amount of heat during the heat exchange changes due to the degree of interaction caused by contact with the target particles contained in the gas G1. In the present embodiment, the catalyst layer 34 is configured to change the state of the target particles contained in the gas G1 by adsorbing the target particles contained in the gas G1 on the surface or inside the catalyst layer 34. In the case where the target particles are hydrogen molecular, the catalyst layer 34 is configured to contain, for example, Pt metal.

The catalyst layer 34 is provided on the insulation film 33 and is configured to exchange heat with the heat flow sensor 32 via the insulation film 33. For example, the catalyst layer 34 is configured to be connected via the insulation film 33 to an area of the housing B1 of the heat flow sensor 32 that faces the measuring surface 32b in the thickness direction. Thus, the catalyst layer 34 is configured to exchange heat with the thermoelectric conversion part 321 via the measuring surface 32b. The catalyst layer 34 is configured so that the heat generated by the first heater 311 is transferred through the heat flow sensor 32, the insulation film 33, etc. This enables the first heater 311 to adjust the temperature of the catalyst layer 34 to a predetermined drive temperature Td (in other words, target temperature). In other words, the first heater 311 is configured to adjust the temperature such that the temperature of the catalyst layer 34 becomes a preset drive temperature Td. The first heater 311 is configured to perform heating based on a drive signal transmitted from the outside. For example, the first heater 311 can be driven while the drive signal is being transmitted if the drive signal is a steady signal. In addition, when the drive signal is an oscillating signal, the first heater 311 can perform heating intermittently in accordance with the frequency of the oscillation (e.g., a modulation frequency described later). In other words, the first heater 311 can be configured to perform temperature adjustment by performing heating at a modulation frequency, which is an example of a first specific frequency.

The change in state of the target particles generates reaction heat. The reaction heat is conducted to the catalyst layer 34 and changes the amount of heat accumulated in the catalyst layer 34 compared to when the target particles are not adsorbed to the catalyst layer 34. For example, in the case where the reaction is an endothermic reaction, the amount of heat accumulated in the catalyst layer 34 decreases, and in the case where the reaction is an exothermic reaction, the amount of heat accumulated in the catalyst layer 34 increases. Accordingly, the amount of heat (in other words, the temperature gradient) transferred to the thermoelectric conversion part 321 via the measuring surface 32b changes. As a result, the temperature gradient in the thermoelectric conversion part 321 in the thickness direction of the heat flow sensor 32 changes in response to the chemical reaction occurring in the catalyst layer 34. The reaction heat generated per unit time is correlated with the amount of reaction between the target particles and the catalyst layer 34. The amount of reaction is also correlated with the concentration of the target particles. Therefore, the electromotive force output from the heat flow sensor 32 is correlated with the concentration of the target particles.

The catalyst layer 34 has a temperature range suitable for reacting with the target particles. For example, the catalyst layer 34 is configured to react with the target particles when its own temperature is equal to or higher than the minimum temperature at which the catalyst layer 34 can be activated (hereinafter, for convenience of explanation, referred to as lower limit reaction temperature). The lower limit reaction temperature is defined, for example, based on the reaction energy required to change the state of the target particles. The reaction rate between the catalyst layer 34 and the target particles generally tends to be faster as the temperature increases. Furthermore, the reaction rate between the catalyst layer 34 and the target particles generally tends to be faster as the temperature increases in the case where the reaction is an endothermic reaction. On the other hand, the reaction rate between the catalyst layer 34 and the target particles generally tends to be slower as the temperature increases in the case where the reaction is exothermic reaction. Thus, the catalyst layer 34 has different reaction rates depending on the temperature region, which may cause the amount of reaction heat transferred to the catalyst layer 34 to change.

The heat flow sensor 32 is configured to generate an electromotive force due to the temperature gradient between the connecting surface 32a and the measuring surface 32b, and further due to the temperature gradient between the substrate 31 and the catalyst layer 34. Thus, the relationship between the electromotive force output from the heat flow sensor 32 and the concentration of the target particles contained in the gas G1 may change depending on the temperature of the catalyst layer 34.

### <Thermometer 35>

The thermometer 35 is configured to measure the temperature of the catalyst layer 34. In the present embodiment, the thermometer 35 is provided so as to be in contact with the catalyst layer 34. The thermometer 35 is configured by, for example, a thermocouple, a resistance thermometer, or the like. The thermometer 35 has a responsiveness such that it is difficult to detect a temperature change in the catalyst layer 34 caused by the reaction heat in the catalyst layer 34, for example, due to its own heat capacity. In other words, the sensitivity of the heat flow sensor 32 is higher than that of the thermometer 35.

As shown in FIG. 1, the sensor unit 2 may further include a reference concentration sensor 4. The reference concentration sensor 4 may include a substrate 41, a reference heat flow sensor 42, an insulation film 43, a reference layer 44, and a reference thermometer 45. It should be noted that these components are merely examples, and the reference concentration sensor 4 may include at least the reference heat flow sensor 42 and the reference layer 44.

### <Substrate 41>

The substrate 41 is a substrate for installing reference concentration sensor 4. The substrate 41 of the present embodiment is a common substrate to the substrate 31. The substrate 41 includes a second heater 411 which is an example of a second temperature adjustment part. The second heater 411 is configured to generate heat based on a drive signal from the outside. The second heater 411 of the present embodiment is integrated with the first heater 311. The second heater 411 may be separated from the first heater 311.

### <Reference Heat Flow Sensor 42>

The reference heat flow sensor 42 is configured to measure information related to the heat flow (e.g., the amount of heat transfer) flowing through the reference heat flow sensor 42. The reference heat flow sensor 42 includes a housing B1 in common with the heat flow sensor 32, and at least one (one in the present embodiment) reference thermoelectric conversion part 421 housed inside the housing B1. The housing of the reference heat flow sensor 42 may be separated from the housing B1 of the heat flow sensor 32.

### <Reference Thermoelectric Conversion Part 421>

The reference thermoelectric conversion part 421 is configured so that a reference electromotive force is generated due to a temperature gradient. For example, the reference thermoelectric conversion part 421 may be configured to output an electromotive force based on the anomalous Nernst effect in the same manner as the thermoelectric conversion part 321. The reference thermoelectric conversion part 421 may be configured to output an electromotive force based on the Seebeck effect. For example, the reference thermoelectric conversion part 421 includes a connecting surface 42a and a measuring surface 42b as a second measuring surface. The connecting surface 42a is connected to the substrate 41 via the housing B1, and thus configured to exchange heat with the substrate 41. The measuring surface 42b is a surface positioned opposite to the connecting surface 42a in the thickness direction of the reference heat flow sensor 42 in the reference thermoelectric conversion part 421. The reference thermoelectric conversion part 421 is configured to output the above-mentioned electromotive force due to the temperature gradient between the connecting surface 42a and the measuring surface 42b. In the present embodiment, the thickness direction of the reference heat flow sensor 42 coincides with the thickness direction of the heat flow sensor 32. The thermoelectric conversion part 321 and the reference thermoelectric conversion part 421 are arranged so as to be electrically insulated from each other.

### <Insulation Film 43>

The insulation film 43 is configured to have an electric insulation property in the same manner as the insulation film 33. The insulation film 43 is provided so as to electrically insulate the measuring surface 42b from an object with which heat is exchanged. In the present embodiment, the insulation film 43 is provided in an area of the housing B1 that faces the measuring surface 42b in the thickness direction of the reference heat flow sensor 42. The insulation film 43 may be directly laminated on the measuring surface 42b.

### <Reference Layer 44>

The reference layer 44 is made of a material that is less reactive with the target particles than the catalyst layer 34. For example, the reference layer 44 is made of a member in which the effect of reaction heat due to reactions with the target particles on the temperature change of the reference layer 44 is negligibly small compared to the catalyst layer 34, or a member that does not react with the target particles. The specific aspect of the reference layer 44 is appropriately determined depending on the type of target particles whose concentration is to be measured. For example, when the target particles are hydrogen molecular, platinum or palladium, or an alloy using these elements, or a metal or alloy constituting a hydrogen storage alloy or the like can be employed as the material constituting the reference layer 44. The structure of such a material is not particularly limited, and may be, for example, a thin-film structure, a bulk structure, a honeycomb structure, a MOF (Metal-Organic Framework), a nanoparticle structure, etc.

The reference layer 44 is provided on the insulation film 43 and is configured to exchange heat with the reference heat flow sensor 42 via the insulation film 43. For example, the reference layer 44 is configured to be connected via the insulation film 43 to an area of the housing B1 of the reference heat flow sensor 42 that faces the measuring surface 42b in the thickness direction. In this manner, the reference layer 44 exchanges heat with the reference thermoelectric conversion part 421 via the measuring surface 42b serving as the second measuring surface. The reference layer 44 is configured so that the heat generated by the second heater 411 is transferred through the reference heat flow sensor 42, the insulation film 43, and the like. This allows the second heater 411 to adjust the temperature of the reference layer 44 to a predetermined drive temperature Td. The specific aspect of the drive temperature Td of the second heater 411 is arbitrary, but for example, the reference layer 44 is configured by the second heater 411 such that the temperature difference between the reference layer 44 and at least one concentration sensor 3 becomes less than an allowable value. It is preferable that the allowance value is small enough to ignore the influence of the heat flow due to factors other than the reaction heat of the catalyst layer 34 and the reference layer 44 themselves on the electromotive force. According to such a configuration, by comparing the respective electromotive forces of the concentration sensor 3 and the reference concentration sensor 4, the accuracy of extracting the contribution of reaction heat in the catalyst layer 34 contained in the electromotive force from the concentration sensor 3 can be improved.

### <Reference Thermometer 45>

The reference thermometer 45 is configured to measure the temperature of the reference layer 44. In the present embodiment, the reference thermometer 45 is provided so as to be in contact with the reference layer 44. The specific aspect of the reference thermometer 45 is arbitrary, but for example, a configuration similar to that of the thermometer 35 can be adopted.

### <Target Heater Th1>

The sensor unit 2 may further include a target heater Th1 as a target temperature adjustment part. The target heater Th1 is configured to adjust the temperature so that the temperature of the gas G1 in the vicinity of the catalyst layer 34 becomes the drive temperature Td. The drive temperature Td of the target heater Th1 is equal to the drive temperature Td of the first heater 311. According to such a configuration, heat exchange other than reaction heat between the gas G1 and the sensor unit 2 can be suppressed, and the electromotive force output from the heat flow sensor 32 can be stabilized.

### <Electromotive Force Measuring Device 5>

The sensor unit 2 may further include an electromotive force measuring device 5. The electromotive force measuring device 5 is configured to measure the electromotive force output from each of the concentration sensor 3 and the reference concentration sensor 4. The electromotive force measuring device 5 comprises, for example, a voltmeter. The electromotive force measuring device 5 may adopt any configuration such as an ammeter, wattmeter, etc. that can measure information correlated with electromotive force.

### <Information Processing Apparatus 6>

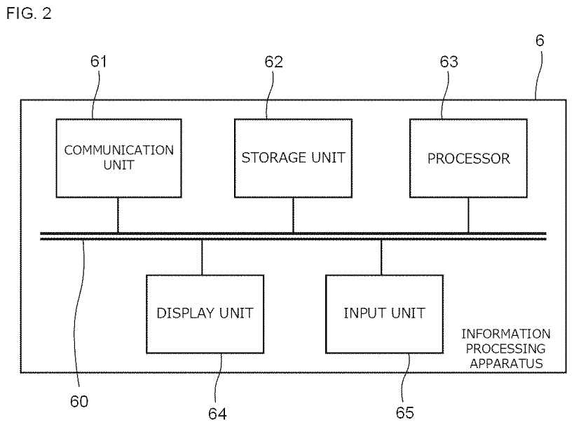

FIG. 2 is a block diagram showing a hardware configuration of the information processing apparatus 6. The information processing apparatus 6 includes a communication unit 61, a storage unit 62, at least one processor 63 as an example of a control circuit, a display unit 64, and an input unit 65. These components are electrically connected with each other via a communication bus 60 inside the information processing apparatus 6.

The communication unit 61 may be preferably wired communication means such as USB, IEEE1394, Thunderbolt (registered trademark), wired LAN network communication, and the like, but may include wireless LAN network communication, mobile communication such as 3G/LTE/5G, Bluetooth (registered trademark) communication, and the like as needed. That is, more preferably, the communication unit 61 may be implemented as a set of two or more of these communication means. That is, the information processing apparatus 6 may communicate various information from outside via the communication unit 61 and a network.

The storage unit 62 is configured to store various information as defined by the above description. For example, the storage unit 62 may be implemented as a storage device such as a solid state drive (SSD) that stores various programs, etc. related to the information processing apparatus 6, which are executed by the processor 63, or as a memory such as a random access memory (RAM) that stores temporarily necessary information (arguments, arrays, etc.) for program calculations. The storage unit 62 stores various programs, variables, etc. related to the information processing apparatus 6 that are executed by the processor 63.

The processor 63 processes and controls overall operation pertaining to the information processing apparatus 6. The processor 63 is, for example, an unshown central processing unit (CPU). The processor 63 reads out a predetermined program stored in the storage unit 62 so as to realize various functions related to the information processing apparatus 6. That is, the information processing by software stored in the storage unit 62 is specifically realized by the processor 63 as an example of hardware, and can be executed as each functional unit included in the processor 63. They will be described in more detail in the next section. The processor 63 is not limited to be a single processor, but may be implemented so as to include a plurality of the processors 63 for each function. Moreover, a combination thereof may be applied.

The display unit 64 may be included in the housing of the information processing apparatus 6, or the display unit 64 may be externally mounted. The display unit 64 displays a graphical user interface (GUI) screen that can be operated by the user. This should be implemented, for example, by using different display devices such as a CRT display, a liquid crystal display, an organic EL display, and a plasma display, depending on the type of the information processing apparatus 6.

The input unit 65 is configured to receive inputs from the user. The input unit 65 may be included in the housing of the information processing apparatus 6, or may be externally mounted. For example, the input unit 65 may be integrated with the display unit 64 and implemented as a touch panel. With a touch panel, the user can input taps, swipes, etc. Of course, a switch button, mouse, QWERTY keyboard, a voice recognition device, a gesture measuring device, a line-of-sight measuring device, a biological signal measuring device, an imaging apparatus, etc. may be employed instead of a touch panel. In other words, the input unit 65 receives operation inputs made by the user. The input unit 65 transfers a signal corresponding to the operation input to the processor 63 via the communication bus 60 as a response. The processor 63 can execute predetermined control or computation as necessary.

The processor 63 is configured to acquire information from the information processing apparatus 6 or other devices. The processor 63 is configured to acquire various information by: reading out the various information stored in a storage area, which is at least a part of the storage unit 62; and writing the readout information into a working area, which is at least a part of the storage unit 62. The storage area is, for example, an area in the storage unit 62, which is implemented as a storage device such as an SSD. The working area is, for example, an area which is implemented as a memory such as RAM. The acquisition by the processor 63 includes the acquisition of the output results of each functional unit included in the processor 63.

The processor 63 generates an external signal to the heaters 311 and 411, thereby causing the first heater 311 and the second heater 411 to generate heat. The external signal may be generated in any manner, but the processor 63 is configured to output the external signal in accordance with, for example, a predetermined timing. In the present embodiment, the processor 63 is configured to generate an external signal at a fixed period in accordance with a specific frequency such as a modulation frequency, thereby causing the heaters 311 and 411 to periodically generate heat. In other words, the processor 63 is configured to drive the heaters 311 and 411 based on a specific frequency. The value of the frequency is arbitrary, but it is preferably set so that noise from the outside world can be removed by a frequency filter or the like.

The processor 63 is configured as an extraction unit to extract a specific frequency component from the acquired information. For example, the processor 63 may convert a signal included in the acquired information into a frequency spectrum by a Fourier transform or the like, and selectively extract the signal strength of the specific frequency from the frequency spectrum. In other words, the processor 63 is configured as an extraction unit to extract a component of a specific frequency such as a modulation frequency from the electromotive force generated from the concentration sensor 3 and the reference concentration sensor 4.

The processor 63 is configured to display various information. The information can be presented to the user via the display unit 64 of the information processing apparatus 6 or other devices. In such a case, for example, the processor 63 controls the display unit 64 of the information processing apparatus 6 to display visual information such as screens, images including still or moving images, icons, messages and the like. The processor 63 may generate only rendering information for displaying the visual information on the display unit 64.

### 2.2 Flow of Information Processing

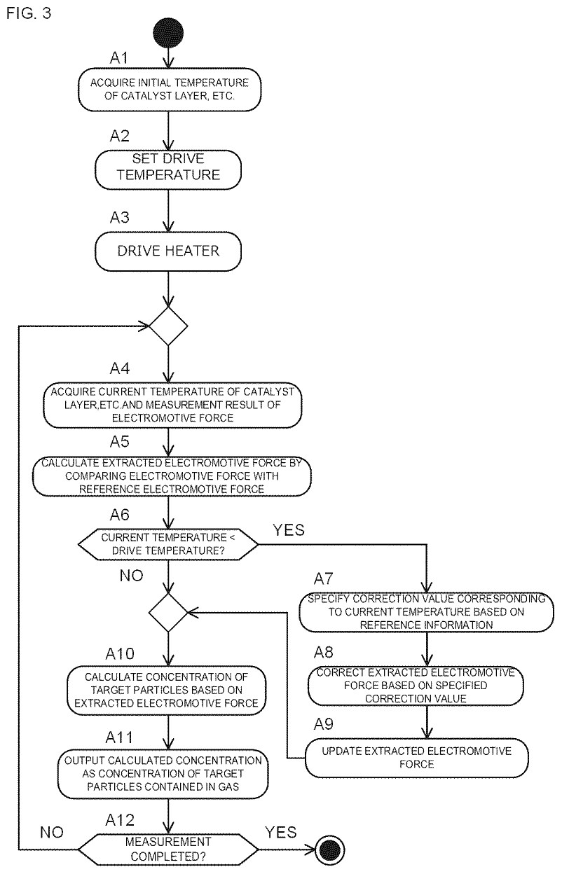

This section describes an example of a flow of the information processing executed in the information processing system 1 described above. FIG. 3 is an activity diagram showing an example of a flow of information processing executed in the information processing system 1. Incidentally, the information processing may include arbitrary exception processing, which is not shown in the drawings. The exception processing includes interruption of the information processing and omission of each process. Selection or input performed in the information processing may be based on operations by the user, or may be automatic not by the user's operations.

### [Activity A1]

Firstly, in Activity A1, the processor 63 acquires an initial temperature of the catalyst layer 34 from the thermometer 35.

### [Activity A2]

Next, in Activity A2, the processor 63 sets the drive temperature Td. In the present embodiment, the drive temperature Td for the first heater 311 and the drive temperature Td for the second heater 411 are common. The drive temperature Td may be specified by the user or may be automatically set depending on the type of the catalyst layer 34.

### [Activity A3]

Next, in Activity A3, the processor 63 drives the heaters 311 and 411. In detail, the processor 63 drives the heaters 311 and 411 so that the temperature measured by the thermometer 35 or the reference thermometer 45 in a steady state becomes approximately equal to the drive temperature Td. As a result, the temperatures of the catalyst layer 34 and the reference layer 44 continuously increase from the initial temperature towards the drive temperature Td.

### [Activity A4]

Next, in Activity A4, the processor 63 acquires, from the electromotive force measuring device 5, the current temperature of the catalyst layer 34 and the measurement result of the electromotive force output from the heat flow sensor 32. As mentioned above, there is a certain correlation between the electromotive force and the concentration of the target particles, and thus the electromotive force output from the heat flow sensor 32 can be considered as an example of a measurement result related to the concentration of the target particles. The current temperature of the catalyst layer 34 is an example of a value related to the current temperature of the catalyst layer 34. The processor 63 may also acquire information other than information related to the concentration sensor 3. For example, the processor 63 may further acquire the current temperature of the reference layer 44 and the reference electromotive force output from the reference layer 44. In the present embodiment, the processor 63 further acquires information related to the temperature of the gas G1 heated by the target heater Th1. The temperature of the gas G1 heated by the target heater Th1 is not limited to the measurement result of a thermometer that measures the temperature of the gas G1, and may be the temperature of the target heater Th1.

[Activity A5]

Next, in Activity A5, the processor 63 calculates an extracted electromotive force by comparing the electromotive force acquired in Activity A4 with the reference electromotive force. The extracted electromotive force is an electromotive force calculated from the electromotive force output from the heat flow sensor 32 so as to limit the influence of the offset, and is calculated, for example, by subtracting the reference electromotive force from the electromotive force of the heat flow sensor 32. However, the present disclosure is not limited thereto, and the extracted electromotive force may be calculated by any function or table obtained by inputting the electromotive force of the heat flow sensor 32 and the reference electromotive force. In this way, the processor 63 can reduce the influence of the offset due to the operating environment of the heat flow sensor 32 from the electromotive force of the heat flow sensor 32, and extract the electromotive force generated by the transfer of reaction heat in the catalyst layer 34 as an extracted electromotive force. That is, the extracted electromotive force is an example of a parameter corrected based on the reference electromotive force, and calculating the extracted electromotive force based on the electromotive force of the heat flow sensor 32 and the reference electromotive force is an example of correcting the electromotive force of the heat flow sensor 32.

### [Activity A6]

Next, in Activity A6, the processor 63 determines whether the current temperature of the catalyst layer 34 is less than the drive temperature Td.

### [Activity A7]

In the case where it is determined that the current temperature of the catalyst layer 34 is less than the drive temperature Td in activity A6, the processor 63 specifies a correction value corresponding to the current temperature of the catalyst layer 34 based on the reference information in Activity A7. In other words, the correction value is specified based on a value related to the temperature of the catalyst layer 34. The reference information is configured to indicate the correspondence relationship between the current temperature of the catalyst layer 34 and the correction value, and is defined in any format, such as a function, or table data. The correspondence relationship is obtained, for example, by testing or simulation of the sensor unit 2.

### [Activity A8]

Next, in Activity A8, the processor 63 corrects the extracted electromotive force obtained in Activity A5 based on the specified correction value. The correction aspect is arbitrary, but for example, the processor 63 corrects the extracted electromotive force by multiplying the extracted electromotive force obtained in Activity A6 by the correction value specified based on the current temperature. In the present embodiment, the processor 63 can further correct the extracted electromotive force based on the temperature of the gas G1 heated by the target heater Th1. In this case, the processor 63 may further employ the extracted electromotive force corrected based on the temperature of the gas G1 as an extracted electromotive force to be used for estimating the concentration. For example, the processor 63 calculates a gas correction value based on the difference between the temperature of the gas G1 and the current temperature of the catalyst layer 34, and performs correction by multiplying the electromotive force output from the heat flow sensor 32 (in the present embodiment, the extracted electromotive force corrected based on the correction value specified in Activity A7) by the gas correction value. The smaller the difference between the temperature of the gas G1 and the current temperature of the catalyst layer 34, the less reaction heat in the catalyst layer 34 is transferred to the gas G1, and thus the gas correction value is defined to tend to become smaller as the difference becomes smaller.

### [Activity A9]

Next, in Activity A9, the processor 63 updates the corrected extracted electromotive force as the extracted electromotive force to be used for estimating the concentration. The process then proceeds to Activity A10.

In the case where it is determined that the current temperature is equal to or higher than the drive temperature Td in Activity A6, the processor 63 skips the processing of Activity A7 to Activity A9 and advances the processing to Activity A10. In this case, the processor 63 employs the extracted electromotive force calculated in Activity A5 as the extracted electromotive force to be used for estimating the concentration.

### [Activity A10]

Then, in Activity A10, the processor 63 calculates the concentration of the target particles based on the extracted electromotive force. The processor 63 calculates the concentration of the target particles corresponding to the extracted electromotive force by using the correspondence relationship (e.g., a function formula or table data) between the extracted electromotive force and the concentration of the target particles which has been obtained in advance.

### [Activity A11]

Then, in Activity A11, the processor 63 outputs the concentration calculated in Activity A10 as the concentration of the target particles contained in the gas G1. The correction is performed using the above correction value in the case where it is determined that the current temperature is less than the drive temperature Td in Activity A6. Thus, it can be said that in Activity A11, the processor 63 outputs the concentration of the target particles contained in the gas G1 which is corrected by using the correction value, based on the correction value specified based on the value related to the temperature of the catalyst layer 34 and the measurement result related to the concentration of the target particles, in at least a portion of the period from the initial temperature until the temperature of the catalyst layer 34 reaches the drive temperature Td. According to such a configuration, the concentration of the target particles can be measured with high accuracy even before the temperature reaches a temperature suitable for interaction with the catalyst layer 34, thereby improving the versatility of the sensor unit 2.

In the present embodiment, the concentration is output using the extracted electromotive force, which is an example of the measurement result related to the concentration of the target particles. Thus, it can be said that the processor 63 further outputs the concentration of the target particles contained in the gas G1, which is further corrected based on the reference electromotive force. According to such a configuration, the change in electromotive force due to slight heat absorption or heat generation by the catalyst layer 34 can be measured more prominently by comparing with the reference electromotive force. Thus, this can further improve the accuracy of measuring the concentration of the target particles before the temperature reaches a temperature suitable for interaction with the catalyst layer 34.

In the present embodiment, the processor 63 corrects the extracted electromotive force using the gas correction value, and thus it can be said that the processor 63 outputs the concentration of the target particles contained in the gas G1 which is corrected based on the temperature of the gas G1 heated by the target heater Th1. According to such a configuration, the temperature of the gas G1 which is in contact with the catalyst layer 34 is stabilized near the drive temperature Td, so that the contribution of heat exchange with the gas G1, which is included in the temperature change of the catalyst layer 34 due to contact with the gas G1, can be further reduced.

### [Activity A12]

Then, in Activity A12, the processor 63 determines whether the measurement by the sensor unit 2 has been completed. In the case where it is determined that the measurement has not completed, the process returns to Activity A4, and the processor 63 again calculates and outputs the concentration of the target particles contained in the gas G1. On the other hand, in the case where it is determined that the measurement by the sensor unit 2 has been completed, the information processing system 1 ends this information processing. 2.3. Another example of information processing

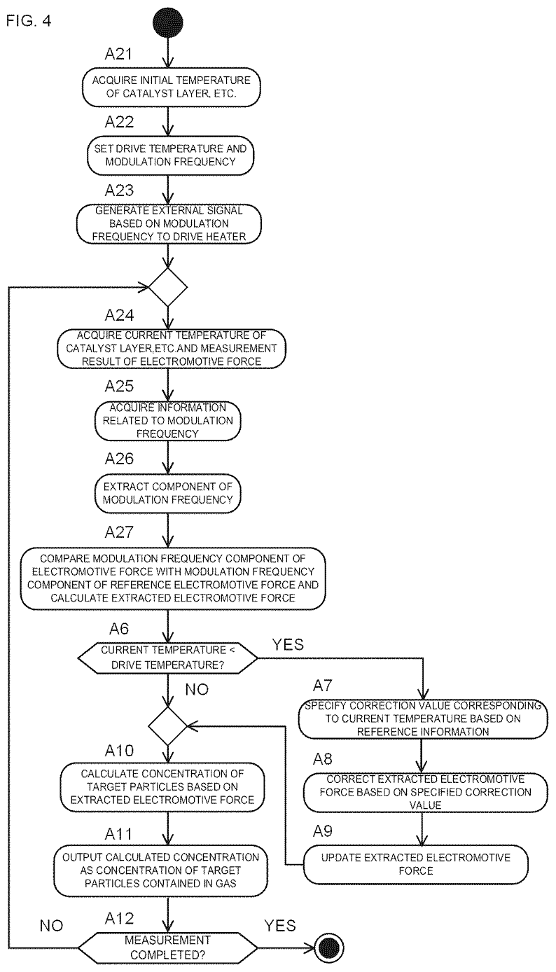

This section describes another example of the information processing described in the previous section. FIG. 4 is an activity diagram showing another example of a flow of the information processing executed in the information processing system 1. This information processing is configured to intentionally apply a periodic modulation to the sensor unit 2 or the gas G1 which is in contact with the sensor unit 2 in the information processing described in the previous section, extract a component of the modulation frequency that is a frequency defining the modulation output from the heat flow sensor 32, from the electromotive force output from the heat flow sensor 32, and output information related to the concentration of the target particles based on the component. In addition, among the information processing described in this section, parts that are common to the information processing described in the previous section may be omitted by assigning the same numbers.

### [Activity A21]

As shown in FIG. 4, firstly, in Activity A21, the processor 63 acquires initial temperatures of the catalyst layer 34 and the reference layer 44, in the same manner as Activity A1.

### [Activity A22]

Next, in Activity A22, the processor 63 sets the drive temperature Td and the modulation frequency. It is preferable that this modulation frequency is different from the frequency band of noise contained in the environment in which the sensor unit 2 operates.

### [Activity A23]

Next, in Activity A23, the processor 63 generates an external signal based on the modulation frequency to drive the heaters 311 and 411.

### [Activity A24]

Next, in Activity A24, the processor 63 acquires, from the electromotive force measuring device 5, the current temperature of the catalyst layer 34 and the measurement result of the electromotive force output from heat flow sensor 32. The details of the process for Activity A24 are the same as for Activity A4. Here, the measurement result of the electromotive force is modulated to oscillate at the modulation frequency as the driving mode of the heaters 311, 411 described above (e.g., on-off of the heaters) changes periodically in accordance with the modulation frequency.

### [Activity A25]

Next, in Activity A25, the processor 63 acquires information related to the modulation frequency as the first specific frequency. For example, the processor 63 refers to the modulation frequency used when generating the drive signal transmitted to the heaters 311 and 411. In addition, in the case where the modulation frequency when the drive signal is generated is defined by a clock signal or the like output by an external device, the processor 63 may acquire information related to the modulation frequency from the external device.

### [Activity A26]

Next, in Activity A26, the processor 63 extracts a component of the modulation frequency from the electromotive force of the heat flow sensor 32 based on the measurement results acquired in Activity A24. Furthermore, in the present embodiment, the processor 63 may extract the modulation frequency component of the reference electromotive force. The specific aspects of the extraction are, for example, as described above. Since the modulation frequency component is configured to be separable from the frequency components caused by noise, such an extraction process can provide information related to the concentration with the influence of noise further reduced.

### [Activity A27]

Next, in Activity A27, the processor 63 compares the modulation frequency component of the electromotive force of the heat flow sensor 32 extracted in Activity A26 with the modulation frequency component of the reference electromotive force, and calculates the extracted electromotive force. The method of calculating the extracted electromotive force is the same as that described in the above-mentioned Activity A5.

Thereafter, the processor 63 executes the processing of Activity A6 to Activity A12 in the information processing described in the previous section, thereby outputting the concentration of the target particles contained in the gas G1, and the processor 63 ends this information processing. That is, the processor 63 outputs the concentration of the target particles contained in the gas G1 based on the components of the modulation frequency included in the measurement result. According to such a configuration, the electromotive force output from the thermoelectric conversion part 321 varies in conjunction with the driving mode of the first heater 311. As a result, the electromotive force contains a component of the modulation frequency that characterizes the driving mode of the first heater 311 more prominently than components of other frequencies. By using a component of the modulation frequency that characterizes the dynamics of the system in this manner, the information processing system 1 can reduce the influence of noise that may be contained in other frequencies.

### 3. Another Example of Information Processing System

In Section 3, yet another example of the information processing system 1 described in Section 2 will be described. In addition, among the configurations of the information processing system 1 described in this section, explanations related to configurations common to the information processing system 1 described in Section 2 may be omitted by assigning the same numbers.

### 3.1. Example of Configuration of Information Processing System

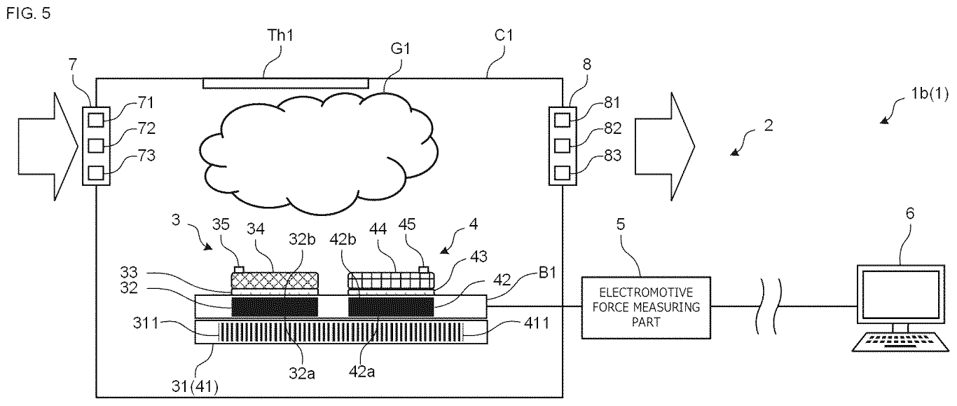

This section describes an example of the configuration of the information processing system 1 according to the present embodiment. Hereafter, for convenience of explanation, the information processing system 1 described in Section 2 will be referred to as an information processing system 1a, and the information processing system 1 according to the present embodiment is referred to as an information processing system 1b. FIG. 5 shows an example of the configuration of the information processing system 1b.

The information processing system 1b includes a sensor unit 2 and an information processing apparatus 6, in the same manner as the information processing system 1a.

The sensor unit 2 of the information processing system 1b includes a concentration sensor 3, a reference concentration sensor 4, and an electromotive force measuring device 5, in the same manner as the information processing system 1a. In addition, the sensor unit 2 of the information processing system 1b may include a target heater Th1. The sensor unit 2 of the information processing system 1b further includes a chamber C1, and an air supply shutter 7 and an exhaust shutter 8 as flow rate adjustment portions.

The chamber C1 is configured to accommodate the concentration sensor 3 and the reference concentration sensor 4, and to define a space within the chamber C1 for contacting the concentration sensor 3 and the reference concentration sensor 4 by introducing the gas G1. In the present embodiment, the electromotive force measuring device 5 is arranged outside the chamber C1. However, the electromotive force measuring device 5 may be arranged inside the chamber C1.

The air supply shutter 7 is configured to supply the gas G1 from the outside to the inside of the chamber C1. The air supply shutter 7 includes an opening and closing device 71, a thermometer 72 and a flow rate sensor 73.

The opening and closing device 71 is configured to control an opened and closed state of the air supply shutter 7 using an opening and closing mechanism such as an electromagnetic valve. When the opening and closing device 71 is in the opened state, the air supply shutter 7 allows the gas G1 to flow from the outside into the interior of the chamber C1 through the air supply shutter 7, and when the opening and closing device 71 is in the closed state, the opening and closing device 71 regulates the flow of the gas G1 into the interior of the chamber C1. The opened and closed state of the opening and closing device 71 is controlled, for example, based on an external signal transmitted from the information processing apparatus 6. For example, in the case where the external signal is a periodic signal that oscillates based on the modulation frequency as a second specific frequency, the opened and closed state of the opening and closing device 71 changes in conjunction with the modulation frequency.

The thermometer 72 is configured to measure the temperature of the gas G1 passing through the air supply shutter 7. This makes it possible to obtain, from the information processing apparatus 6, information related to the heat flow corrected based on the temperature difference between the inside and outside of the chamber C1.

The flow rate sensor 73 is configured to measure the flow rate of the gas G1 introduced into the catalyst layer 34. Any configuration may be employed for the flow rate sensor 73, such as an ultrasonic type, an electromagnetic type, a Coriolis type, or an impeller type.

The exhaust shutter 8 is configured to exhaust the gas G1 from the inside of the chamber C1 to the outside. The exhaust shutter 8 includes an opening and closing device 81, a thermometer 82 and a flow rate sensor 83.

The opening and closing device 81 is configured to control an opened and closed state of the exhaust shutter 8 using an opening and closing mechanism such as an electromagnetic valve. When the opening and closing device 81 is in the opened state, the exhaust shutter 8 allows the gas G1 to flow from the inside of the chamber C1 to the outside through the exhaust shutter 8, and when the opening and closing device 81 is in the closed state, the opening and closing device 81 regulates the flow of the gas G1 to the outside. As a result, at least a portion of the gas G1 that flows in from the air supply shutter 7 reacts with the catalyst layer 34 of the sensor unit 2, and then flows out to the outside through the exhaust shutter 8. The opened and closed state of the opening and closing device 81 is controlled, for example, based on an external signal transmitted from the information processing apparatus 6. For example, in the case where the external signal is a periodic signal that oscillates based on the modulation frequency described above, the opened and closed state of the opening and closing device 81 changes in conjunction with the modulation frequency. For example, the air supply shutter 7 and the exhaust shutter 8 are configured to adjust the flow rate of the gas G1 introduced into at least one concentration sensor 3 in accordance with the second specific frequency. In the case where the opening and closing device 71 and the opening and closing device 81 are controlled based on a common external signal (and further, a common clock signal), the air supply shutter 7 and the exhaust shutter 8 can operate in conjunction with each other.

### 3.2. Flow of Information Processing According to Information Processing System 1b

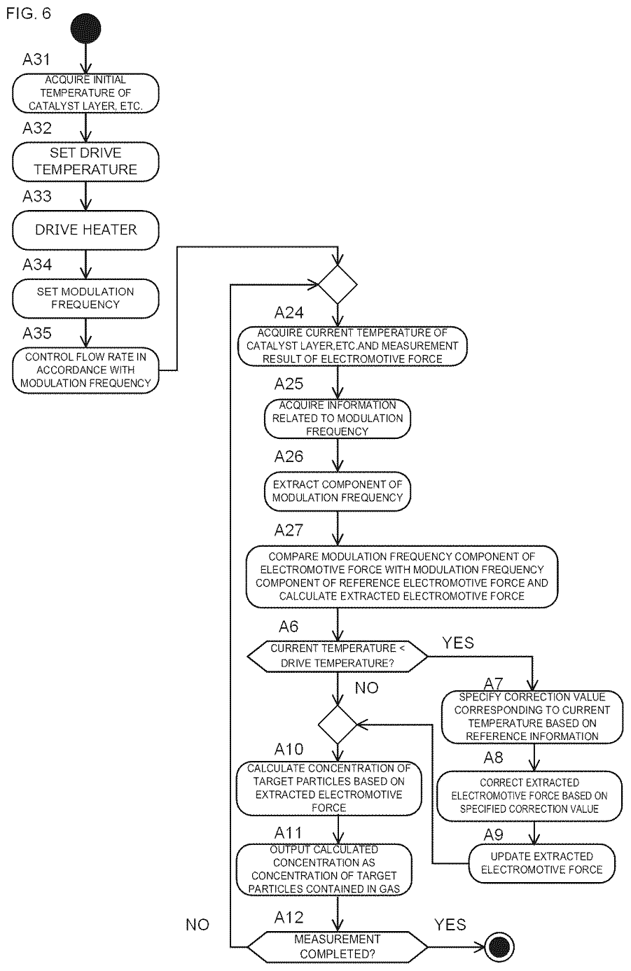

This section describes a flow of the information processing executed in the information processing system 1b described above. FIG. 6 is an activity diagram showing an example of a flow of the information processing executed in the information processing system 1b. This information processing is configured to intentionally apply a periodic modulation to the sensor unit 2 or a supply aspect of the gas G1 which is in contact with the sensor unit 2 in the information processing described in the previous section, extract a component of the modulation frequency that is a frequency defining the modulation output from the heat flow sensor 32, from the electromotive force output from the heat flow sensor 32, and output information related to the concentration of the target particles based on the component. In addition, among the information processing described in this section, parts that are common to the information processing described in the previous section may be omitted by assigning the same numbers.

### [Activity A31]

Firstly, in Activity A31, the processor 63 acquires an initial temperature of the catalyst layer 34, etc. in the same manner as Activity A1.

### [Activity A32]

Next, in Activity A32, the processor 63 sets the drive temperature Td in the same manner as Activity A2.

### [Activity A33]

Next, in Activity A33, the processor 63 drives the heaters 311 and 411 based on the drive temperature Td, in the same manner as Activity A3.

### [Activity A34]

Next, in Activity A34, the processor 63 sets the modulation frequency in the same manner as Activity A22. The modulation frequency in Activity A22 defines a first specific frequency which is the frequency of the external signal that drives the heaters 311 and 411, whereas the modulation frequency in Activity A34 defines a second specific frequency which is the frequency of the signal that drives the opening and closing devices 71 and 81.

### [Activity A35]

Next, in Activity A35, the processor 63 controls the flow rate of the gas G1 flowing into or out of the chamber C1 in accordance with the modulation frequency set in Activity A34. For example, the processor 63 modulates the flow rate of the gas G1 passing through the chamber C1 at a period corresponding to the modulation frequency by changing the opened and closed state of the opening and closing devices 71 and 81 so as to synchronize with the modulation frequency. As a result, the amount of the gas G1 that is in contact with the concentration sensor 3 and the reference concentration sensor 4 changes in conjunction with the modulation frequency. Accordingly, the electromotive force of the concentration sensor 3 and the reference electromotive force of the reference concentration sensor 4 easily vary periodically at a period defined by the modulation frequency, depending on the changing amount of the gas G1. Thus, the frequency spectrum of the electromotive force of the concentration sensor 3 and the reference electromotive force has a peak at the set modulation frequency. The peak is set to be different from the frequency band of noise superimposed on the measurement results of the concentration sensor 3. Therefore, the processor 63 can selectively extract the amount due to the change in the concentration of the gas G1 by removing the frequency components on which the noise is superimposed.

Thereafter, the processor 63 executes the same process as the other example of the information processing described in Section 2.3, and ends this information processing. For example, the processor 63 extracts the components of the modulation frequency from the electromotive force of the heat flow sensor 32 and the reference electromotive force in Activity A26 and compares them in Activity A27 to calculate the extracted electromotive force. The extracted electromotive force calculated by comparing the components of the modulation frequency is an example of a value corrected based on the flow rate of the gas G1. Thus, the processor 63 outputs the concentration of the target particles contained in the gas G1 based on the components of the modulation frequency of the electromotive force of the heat flow sensor 32 as the measurement result. According to such a configuration, the electromotive force output from the reference thermoelectric conversion part 421 varies in conjunction with the flow rate of the gas G1 introduced toward the catalyst layer 34. Thus, the electromotive force contains a component of the second specific frequency that characterizes the flow rate of the gas G1 more prominently than the components of other frequencies. By using the component of the second specific frequency that characterizes the quantitative dynamics of the interaction in this manner, the information processing system 1 can reduce the influence of noise that may be contained in other frequencies.

The processor 63 may also acquire information related to the flow rate of the gas G1 from the flow rate sensor 73 (e.g., the flow velocity of the gas G1 flowing through the air supply shutter 7 and the exhaust shutter 8, the pressure change in the chamber C1, etc.) and output the concentration of the target particles contained in the gas G1 which is corrected based on the acquired flow rate of the gas G1. According to such a configuration, the concentration can be evaluated based on the total amount of the gas G1 introduced into the catalyst layer 34 per unit time, thereby providing a more accurate sensor unit 2. In this case, the processor 63 may further specify a gas correction value corresponding to the flow rate of the gas G1 in Activity A7, for example, and further correct the extracted electromotive force by multiplying the extracted electromotive force by the gas correction value in Activity A8.

### [Others]

Each of the above information processing systems 1 may be implemented, for example, as follows.

The temperature adjustment part is arbitrary as long as it can adjust the temperature of the catalyst layer 34, etc. and does not have to be incorporated inside the substrate 31. For example, the first heater 311 and the second heater 411 may be installed on an external surface of the substrate 31, for example, on the same surface as the surface on which the heat flow sensor 32 is provided.

The temperature adjustment part is arbitrary as long as it can adjust the temperature of the catalyst layer 34 etc., and is not limited to those configured to adjust the temperature by heating the first heater 311, the second heater 411, etc. For example, the temperature adjustment part may be a heat-absorbing element such as a Peltier device, or a cooling device such as a cooler.

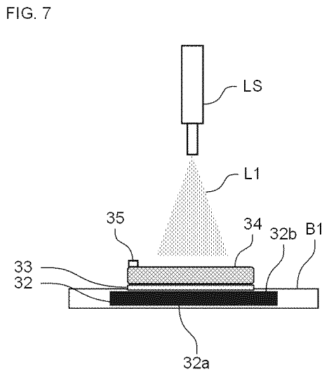

The temperature adjustment part does not have to be configured to come into contact with the concentration sensor 3 and the reference concentration sensor 4, like the heaters 311, 411. The temperature adjustment part may be a light source capable of emitting light, such as infrared light, that can be absorbed by the catalyst layer 34, etc. FIG. 7 shows an example of the concentration sensor 3 in the case where a light source is used as the temperature adjustment part. As shown in FIG. 7, the first heater 311 is implemented by a light source LS. The light source LS is configured to emit irradiation light L1 to the catalyst layer 34. The irradiation light L1 may be any light as long as it is configured to be absorbed by the catalyst layer 34 and converted into heat. The light source LS is arranged so as to face the surface of the catalyst layer 34 opposite the surface that comes into contact with the heat flow sensor 32 in the thickness direction of the heat flow sensor 32. The light source LS emits irradiation light L1 to at least a portion of the catalyst layer 34, for example, the entire surface of the catalyst layer 34. This causes the catalyst layer 34 to be uniformly heated. According to such a configuration, the contact area between the catalyst layer 34 and the gas G1 can be preferentially heated to the drive temperature Td without going through the heat flow sensor 32, thereby reducing the influence of the first heater 311 on the measurement results of the heat flow sensor 32.

At least a portion of the functions implemented by the processor 63 described above may be implemented by analog circuitry. For example, the extraction of the modulation frequency described above may be performed by an existing lock-in detector, which is different from the information processing apparatus 6. Moreover, the extraction of the modulation frequency described above may be performed using a filter circuit (e.g., a low-pass filter, a high-pass filter, a band-pass filter, etc.) configured to pass the modulation frequency. In other words, the information processing system 1 is not limited to the processor 63, and may include a control circuit configured to realize the information processing described above.

The value related to the current temperature of the catalyst layer 34 is not limited to the current temperature of the catalyst layer 34, but may be any value correlated with the temperature of the catalyst layer 34.

The processor 63 may acquire a value related to a heating value of the first heater 311, and may output the concentration of the target particles contained in the gas G1 which is further corrected based on the value related to the heating value or an endothermic value. According to such a configuration, it is possible to reduce the uncertainty in the measurement of the concentration of the target particles due to the temperature adjustment characteristics of the heater before the temperature reaches a temperature suitable for interaction by the catalyst layer 34, and to provide a more accurate sensor unit 2. The heat value or the endothermic value of the first heater 311 may be specified based on, for example, the amount of energy (e.g., current) supplied to the first heater 311 and the operating efficiency of the first heater 311. The processor 63 may calculate the extracted electromotive force, for example, by correcting the electromotive force output from the above-mentioned heat flow sensor 32 with a heat generation correction value corresponding to the heat value of the first heater 311 (for example, a value calculated based on the amount of current included in the drive signal). In this case, the sensor unit 2 may not include the reference concentration sensor 4.

The sensor unit 2 may further include a heat sink. The heat sink may be attached to the substrate 31, for example, and configured to exchange heat with the connecting surface 32a of the thermoelectric conversion part 321. This makes it possible to stabilize the temperature of the connecting surface 32a of the thermoelectric conversion part 321 and to specify the correspondence relationship between the electromotive force and the concentration of the target particles with higher accuracy.

The interaction portion is not limited to a catalyst such as the catalyst layer 34, but may be any portion that interacts with the target particles contained in the gas G1. For example, the interaction portion may be configured to adsorb target particles, such as a hydrogen storage alloy.

In each of the above embodiments, the sensor unit 2 may not include the reference concentration sensor 4. In this case, the processor 63 may employ the electromotive force output from the heat flow sensor 32 as an extracted electromotive force, and calculate the concentration of the target particles based on the extracted electromotive force.

The above-mentioned information processing system 1 is not limited to one that includes the sensor unit 2. For example, the information processing system 1 may be configured to execute each of the above information processing for the sensor unit 2 provided outside of the information processing system 1.

In each of the above-mentioned embodiments, the sensor unit 2 alone can constitute an independent technical concept.

The information processing system 1 may be an on-premises system or a cloud-based system. As a cloud-based information processing system 1, the above-mentioned functions and processing may be provided, for example, in the form of Saas (Software as a Service) or cloud computing.

In the above-described embodiment, the information processing system 1 executes various storage and control operations, but a plurality of external devices may be used instead of the information processing system 1. In other words, various information and programs may be divided to be stored into the plurality of the external devices by using blockchain technology, or the like.

The above-mentioned embodiment is not limited to the information processing system 1, and may be an information processing method or an information processing program. The information processing method includes each of the steps of the information processing system 1. The information processing program allows at least one computer to execute each of the steps of the information processing system 1.

The above-mentioned embodiments may be provided in each of the following aspects.

(1) An information processing system for a sensor unit, the sensor unit comprising at least one concentration sensor configured to come into contact with fluid and output an electromotive force that has a correlation with a concentration of target particles contained in the fluid, the concentration sensor comprising: a first thermoelectric conversion part configured to generate the electromotive force due to a temperature gradient and including a first measuring surface; an interaction portion configured to perform heat exchange with the first thermoelectric conversion part via the first measuring surface and configured so that, when being activated, an amount of heat during the heat exchange changes due to a degree of interaction caused by contact with the target particles contained in the fluid; and a first temperature adjustment part configured to adjust temperature such that the temperature of the interaction portion becomes a preset drive temperature that is higher than a minimum temperature at which the interaction portion can be activated, the information processing system comprising at least one control circuit configured to execute each of following steps including: an acquisition step of acquiring, from the sensor unit, at least a measurement result related to the concentration of the target particles and a value related to the temperature of the interaction portion; and an output step of outputting a concentration of the target particles contained in the fluid which is corrected by using a correction value, based on the correction value specified based on a value related to the temperature of the interaction portion and the measurement result in at least a portion of period from an initial temperature until the temperature of the interaction portion reaches the drive temperature.

According to such a configuration, the concentration of the target particles can be measured with high accuracy even before the temperature reaches a temperature suitable for interaction with the interaction portion, thereby improving the versatility of the sensor unit.

(2) The information processing system according to (1), wherein: the sensor unit further comprises a second thermoelectric conversion part, a reference portion, and a second temperature adjustment part, the second thermoelectric conversion part includes a second measuring surface and is configured so that a reference electromotive force is generated due to a temperature gradient, the reference portion is made of a material that is less reactive with the target particles than the interaction portion, is configured to exchange heat with the second thermoelectric conversion part via the second measuring surface, and is configured by the second temperature adjustment part such that a temperature difference between the reference portion and the at least one concentration sensor becomes less than an allowable value, the at least one control circuit is configured to further execute each of following steps including: the acquisition step of further acquiring the reference electromotive force; and the output step of outputting a concentration of the target particles contained in the fluid which is further corrected based on the reference electromotive force.

According to such a configuration, the change in electromotive force due to slight heat absorption or heat generation by the interaction portion can be measured more prominently by comparing with the reference electromotive force. Thus, this can further improve the accuracy of the measuring the concentration of the target particles before the temperature reaches a temperature suitable for interaction by the interaction portion.

(3) The information processing system according to (1) or (2), wherein: the at least one control circuit is configured to further execute the acquisition step of acquiring a value related to a heating value or an endothermic value of the first temperature adjustment part, and the output step of outputting a concentration of the target particles contained in the fluid which is further corrected based on the value related to the heating value or the endothermic value.

According to such a configuration, it is possible to reduce the uncertainty in the measurement of the concentration of the target particles due to the temperature adjustment characteristics of the heater before the temperature reaches a temperature suitable for interaction by the interaction portion, and to provide a more accurate sensor unit.

(4) The information processing system according to any one of (1) to (3), wherein: the sensor unit further comprises a target temperature adjustment part configured to perform temperature adjustment so that temperature of the fluid in a vicinity of the interaction portion becomes the drive temperature, the at least one control circuit is configured to further execute each of following steps including: the acquisition step of further acquiring temperature of the fluid adjusted by the target temperature adjustment part; and the output step of outputting a concentration of the target particles contained in the fluid which is further corrected based on the temperature of the fluid . . . .

According to such a configuration, the temperature of the fluid which is in contact with the interaction portion is stabilized near the drive temperature, so that the contribution of heat exchange with the fluid, which is included in the temperature change of the interaction portion due to contact with the fluid, can be further reduced.

(5) The information processing system according to any one of (1) to (4), wherein: the first temperature adjustment part is configured to perform the temperature adjustment by performing cooling or heating at a first specific frequency, the at least one control circuit is configured to further execute each of following steps including: the acquisition step of further acquiring information related to the first specific frequency; a first extraction step of extracting a component of the first specific frequency from the electromotive force; and the output step of outputting a concentration of the target particles contained in the fluid based on the component of the first specific frequency included in the measurement result.

According to such a configuration, the electromotive force output from the first thermoelectric conversion part varies in conjunction with the driving mode of the first temperature adjustment part. Thus, the electromotive force contains a component of the first specific frequency that characterizes the driving mode of the first temperature adjustment part more prominently than components of other frequencies. By using the component of the first specific frequency that characterizes the dynamics of the system in this manner, the information processing system can reduce the influence of noise that may be included in other frequencies.

(6) The information processing system according to any one of (1) to (5), wherein: the sensor unit further comprises a flow rate adjustment portion configured to adjust a flow rate of the fluid introduced into the at least one concentration sensor in accordance with a second specific frequency, the at least one control circuit is configured to further execute each of following steps including: the acquisition step of further acquiring information related to the second specific frequency; a second extraction step of extracting a component of the second specific frequency from the electromotive force; and the output step of outputting a concentration of the target particles contained in the fluid based on the component of the second specific frequency as the measurement result.

According to such a configuration, the electromotive force output from the second thermoelectric conversion part varies in conjunction with the flow rate of the fluid introduced toward the interaction portion. Therefore, the electromotive force contains a component of the second specific frequency that characterizes the flow rate of the fluid more prominently than the components of other frequencies. By using the component of the second specific frequency that characterizes the quantitative dynamics of the interaction in this manner, the information processing system can reduce the influence of noise that may be included in other frequencies.

(7) The information processing system according to any one of (1) to (6), wherein: the sensor unit further comprises a flow rate sensor configured to measure a flow rate of the fluid introduced into the interaction portion, the at least one control circuit is configured to further execute each of following steps including: the acquisition step of further acquiring information related to the flow rate of the fluid; and the output step of outputting a concentration of the target particles contained in the fluid which is corrected based on the flow rate of the fluid . . . .

According to such a configuration, the concentration can be evaluated based on the total amount of the fluid introduced into the interaction portion per unit time, thereby providing a more accurate sensor unit.

(8) The information processing system according to any one of (1) to (7), comprising: the sensor unit.

(9) The information processing system according to any one of (1) to (8), wherein: the first thermoelectric conversion part is configured to output the electromotive force based on an anomalous Nernst effect.

(10) An Information processing method, comprising each of the steps executed by the information processing system for a sensor unit according to any one of (1) to (9).

(11) A program, configured to allow at least one computer to execute each of the steps of the information processing system for a sensor unit according to any one of (1) to (9).

Of course, the present disclosure is not limited to the above aspects.

Finally, various embodiments of the present disclosure have been described, but these are presented as examples and are not intended to limit the scope of the invention. Novel embodiments can be implemented in various other forms, and various omissions, replacements, and modifications can be made within the scope of the spirit of the invention. The embodiments and its modifications are included in the scope and the spirit of the invention and are included in the scope of the invention described in claims and the equivalent scope thereof.

In addition, the following aspects should also be noted.

In the gas sensor (an example of a device) according to the present embodiment, a heat flow sensor is provided on a substrate, and a catalyst layer or an adsorption layer for combustion is provided on an upper portion of the heat flow sensor. An insulation layer may be provided between the heat flow sensor and the catalyst layer or the adsorption layer. However, the insulation layer may not be provided, for example, as long as the catalyst layer and the heat flow sensor are electrically isolated. The combustion catalyst may be, for example, a commonly used material such as platinum. The adsorbent used in the adsorption layer may be MOF (metal organic framework), alumina, silica, zeolite, or other porous materials. A temperature control device such as a heater or Peltier device for temperature control may be provided in or near the gas sensor. This makes it possible to make a gas sensor that has low heat capacity, has a small size, and has a high-speed response. In the present embodiment and each of the modified examples, a heater is disclosed as a temperature control means, but the temperature control means may be not only one that performs heating but also one that performs cooling, or may achieve both. Also, a temperature sensor may be provided separately, and the sensor sensitivity, sensor offset, etc. may be adjusted by an analog/digital circuit using the temperature sensor.

A modified example of the present embodiment will now be described. In the modified example, multiple heat flow sensors may be provided, one of which may be provided with a catalyst layer or an adsorption layer, and the other may be provided with a reference layer whose heat capacity and thermal resistance are equivalent to those of the catalyst layer or the adsorption layer. By comparing the difference between the output of the heat flow sensor on the catalyst/adsorption side and the output of the heat flow sensor on the reference side, it is possible to detect heat generation generated only by the object. This makes it possible to detect only heat generation and heat absorption caused by the object, such as gas, in the heat flow sensor.

Another modified example of the present embodiment will be described. In the above modified example, disturbances such as those from a heater were cancelled out by a reference, but in this modified example, information on the heating value of the heater can be obtained, so that the heating value of the object can be detected, for example, by taking the difference between the signals corresponding to the output of the heat flow sensor and the heating value of the heater. This reduces the influence of heating and adsorbing by a temperature control device such as a heater when sensing exothermic or endothermic reactions.

As a further modified example, there is the following configuration for creating a stable thermal space.

(1) By controlling the value of the temperature sensor that detects the temperature in the vicinity of the gas reaction field to be constant and creating a stable thermal space environment, the measurement accuracy becomes more stable. This temperature sensor may be arranged in the vicinity of the heater or in the vicinity of the heat flow sensor, and there are no limitations on the installation position as long as the field temperature can be determined. It is also possible to use known techniques that can predict the field temperature.

(2) The heater may be turned on for a certain period of time, a measurement may be performed at that timing, then the heating may be stopped, and the heater may be turned on again when performing the measurement. The heating pattern may be any pattern.

(3) The heater is constantly generating a constant amount of heat, a state of thermal equilibrium is maintained, and a constant value of heat from the heater and the atmosphere is maintained. In this state, an offset component of the output of the heat flow sensor can be obtained, and thus measurements may be performed so that the sensor signal output can detect heat generation generated only by the object.

The above-mentioned configurations (1), (2), and (3) may be used alone or in any combination.

Another modified example of the present embodiment will be described. The temperature control device (e.g., a heater) may be any device or may have any configuration as long as it is capable of transferring heat to the catalyst layer or the adsorption layer. For example, the heater may be provided adjacent to the catalyst layer or the adsorption layer, or may be one that heats the catalyst layer or the adsorption layer by means of an infrared heater or the like.

The device may also be housed in a housing such as a temperature-controlled bath (e.g., a thermostatic bath). In this case, the temperature-controlled bath may be controllable to a plurality of temperature ranges, such as lower temperature (lower than the reaction temperature), room temperature, higher temperature, etc. Consequently, for example, lowering the temperature inside the housing causes the gas to be adsorbed on the catalyst layer or adsorption layer, and then it is possible to raise the temperature to promote the reaction or desorb the gas.

Furthermore, this device and system may be configured to control the pressure inside the housing. By increasing the pressure (air pressure) of the catalyst or adsorbent, the amount of reaction or adsorption can be increased, and the heat value or the endothermic value can be improved. As a result, higher sensitivity can be achieved. In addition, the reaction can be stopped or the desorbing can be performed by lowering the pressure, so that the reactivity can be controlled. Thus, highly reproducible measurements are possible.

In another modified example, sensing can be performed by applying periodic heat or pressure (or temperature, or current, or voltage, or power) at a predetermined period (e.g. a sine wave) using a heat source such as pressure and/or a heater.

S1=k*Q1+off1 Heat flow sensor signal
k: sensor sensitivity, off1: sensor offset, A (modulation of reactivity due to temperature and pressure)
If the case where the heater for square wave is being driven is referred to as Phase 0, and if the case where the heater is not being driven is referred to as Phase 1, Phase 0-Phase 1

S1=−(kQ)*A
and the signal drops to a DC level, making signal processing simple. It is also possible to increase sensitivity by inputting a frequency signal and executing signal processing such as with a lock-in amplifier or heterodyne. In this modified example, the method of applying heat and pressure for a certain period of time is described, but it goes without saying that any heat, pressure, or temperature waveforms can be acceptable.

The materials for the catalyst layer and adsorption layer may also be mixed with a carrier to increase the surface area. This can increase the amount of adsorption of gas and improve efficiency.

It is also preferable that the gas sensor is not subjected to filed flows such as air currents, but sensing that takes the field flow into account is possible by monitoring the flow velocity of such a field. For example, it is possible to use the field flow velocity information to correct the sensor output with analog and/or digital circuitry.

In addition, to stabilize the heat state of the gas sensor, a heat sink may be provided for the catalyst layer, the adsorption layer, the heat flow sensor, heater, etc. as appropriate.

1. An information processing system for a sensor unit, the sensor unit comprising at least one concentration sensor configured to come into contact with fluid and output an electromotive force that has a correlation with a concentration of target particles contained in the fluid, the concentration sensor comprising:
a first thermoelectric conversion part configured to generate the electromotive force due to a temperature gradient and including a first measuring surface;
an interaction portion
configured to perform heat exchange with the first thermoelectric conversion part via the first measuring surface, and
configured so that, when being activated, an amount of heat during the heat exchange changes due to a degree of interaction caused by contact with the target particles contained in the fluid; and
a first temperature adjustment part configured to adjust temperature such that the temperature of the interaction portion becomes a preset drive temperature that is higher than a minimum temperature at which the interaction portion can be activated,
the information processing system comprising at least one control circuit configured to execute each of following steps including:
an acquisition step of acquiring, from the sensor unit, at least a measurement result related to the concentration of the target particles and a value related to the temperature of the interaction portion; and
an output step of outputting a concentration of the target particles contained in the fluid which is corrected by using a correction value, based on the correction value specified based on a value related to the temperature of the interaction portion and the measurement result in at least a portion of period from an initial temperature until the temperature of the interaction portion reaches the drive temperature.

2. The information processing system according to claim 1, wherein:
the sensor unit further comprises a second thermoelectric conversion part, a reference portion, and a second temperature adjustment part,
the second thermoelectric conversion part includes a second measuring surface and is configured so that a reference electromotive force is generated due to a temperature gradient,
the reference portion
is made of a material that is less reactive with the target particles than the interaction portion,
is configured to exchange heat with the second thermoelectric conversion part via the second measuring surface, and
is configured by the second temperature adjustment part such that a temperature difference between the reference portion and the at least one concentration sensor becomes less than an allowable value,
the at least one control circuit is configured to further execute each of following steps including:
the acquisition step of further acquiring the reference electromotive force; and
the output step of outputting a concentration of the target particles contained in the fluid which is further corrected based on the reference electromotive force.

3. The information processing system according to claim 1, wherein:
the at least one control circuit is configured to further execute
the acquisition step of acquiring a value related to a heating value or an endothermic value of the first temperature adjustment part, and
the output step of outputting a concentration of the target particles contained in the fluid which is further corrected based on the value related to the heating value or the endothermic value.

4. The information processing system according to claim 1, wherein:
the sensor unit further comprises a target temperature adjustment part configured to perform temperature adjustment so that temperature of the fluid in a vicinity of the interaction portion becomes the drive temperature,
the at least one control circuit is configured to further execute each of following steps including:
the acquisition step of further acquiring temperature of the fluid adjusted by the target temperature adjustment part; and
the output step of outputting a concentration of the target particles contained in the fluid which is further corrected based on the temperature of the fluid.

5. The information processing system according to claim 1, wherein:
the first temperature adjustment part is configured to perform the temperature adjustment by performing cooling or heating at a first specific frequency,
the at least one control circuit is configured to further execute each of following steps including:
the acquisition step of further acquiring information related to the first specific frequency;
a first extraction step of extracting a component of the first specific frequency from the electromotive force; and
the output step of outputting a concentration of the target particles contained in the fluid based on the component of the first specific frequency included in the measurement result.

6. The information processing system according to claim 1, wherein:
the sensor unit further comprises a flow rate adjustment portion configured to adjust a flow rate of the fluid introduced into the at least one concentration sensor in accordance with a second specific frequency,
the at least one control circuit is configured to further execute each of following steps including:
the acquisition step of further acquiring information related to the second specific frequency;
a second extraction step of extracting a component of the second specific frequency from the electromotive force; and
the output step of outputting a concentration of the target particles contained in the fluid based on the component of the second specific frequency as the measurement result.

7. The information processing system according to claim 1, wherein:
the sensor unit further comprises a flow rate sensor configured to measure a flow rate of the fluid introduced into the interaction portion,
the at least one control circuit is configured to further execute each of following steps including:
the acquisition step of further acquiring information related to the flow rate of the fluid; and
the output step of outputting a concentration of the target particles contained in the fluid which is corrected based on the flow rate of the fluid.

8. The information processing system according to claim 1, comprising:
the sensor unit.

9. The information processing system according to claim 1, wherein:
the first thermoelectric conversion part is configured to output the electromotive force based on an anomalous Nernst effect.

10. An information processing method, comprising each of the steps executed by the information processing system for a sensor unit according to claim 1.

11. A non-transitory computer-readable storage medium storing a program, configured to allow at least one computer to execute each of the steps of the information processing system for a sensor unit according to claim 1.
